(19) United States
(12) Patent Application Publication
(10) Pub. No.: US 2025/0198546 A1
(43) Pub. Date: Jun. 19, 2025

(54) DRYER VENT HOSE DEVICE

(71) Applicants: Daniel Angelillo, Milton (CA); George Roti, Milton (CA)

(72) Inventors: Daniel Angelillo, Milton (CA); George Roti, Milton (CA)

(21) Appl. No.: 18/538,261

(22) Filed: Dec. 13, 2023

(51) Int. Cl. F16L 11/12; D06F 58/20; F16L 27/12

(52) U.S. Cl. CPC F16L 11/12; D06F 58/20; F16L 27/1275

(57) ABSTRACT

A dryer vent hose device for inhibiting kinking, constriction and clogging of the hose includes a tube having a first end, a second end, and a peripheral wall that is attached to and extends between the first end and the second end. A wire is coupled to the peripheral wall. The wire extends from the first end to the second end. The wire has a helix shape forming a plurality of loops along a length of the peripheral wall. The wire may further include a first side having a first polarity and a second side having a second polarity. The first polarity and the second polarity are magnetically attracted to each other such that the plurality of loops are magnetically attracted to each other and retract inwardly toward each other.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vent hoses and more particularly pertains to a new vent hose for inhibiting kinking, constriction and clogging of the hose.

### (2) Description of Related Art Including Information Disclosed Under 37 CFR 1.97 and 1.98

The prior art relates to vent hoses. More specifically, the prior art relates to vent hoses for connecting an electric dryer vent with an exhaust vent. Typically, at least a portion of the length of such vent hoses, or duct connectors, will sag between the electric dryer and the exhaust vent. Sagging can lead to lint blockage, which can result in fires. Thus, there is a need in the art for a duct connector system that eliminates sag in the duct connector to reduce the chances of lint blockage and fires.

### BRIEF SUMMARY OF THE INVENTION

An embodiment of the disclosure meets the needs presented above by generally comprising a tube having a first end, a second end, and a peripheral wall that is attached to and extends between the first end and the second end. A wire is coupled to the peripheral wall. The wire extends from the first end to the second end. The wire comprises a helix shape forming a plurality of loops along a length of the peripheral wall. The wire may further comprise a first side having a first polarity and a second side having a second polarity. The first polarity and the second polarity are magnetically attracted to each other whereby the plurality of loops are magnetically attracted to each other thereby retracting the plurality of loops inwardly toward each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a dryer vent hose device according to an embodiment of the disclosure.

FIG. 2 is a side view of an embodiment of the disclosure.

FIG. 3 is a cross-sectional view of an embodiment of the disclosure.

FIG. 4 is an in-use view of an embodiment of the disclosure.

### DETAILED DESCRIPTION OF THE INVENTION

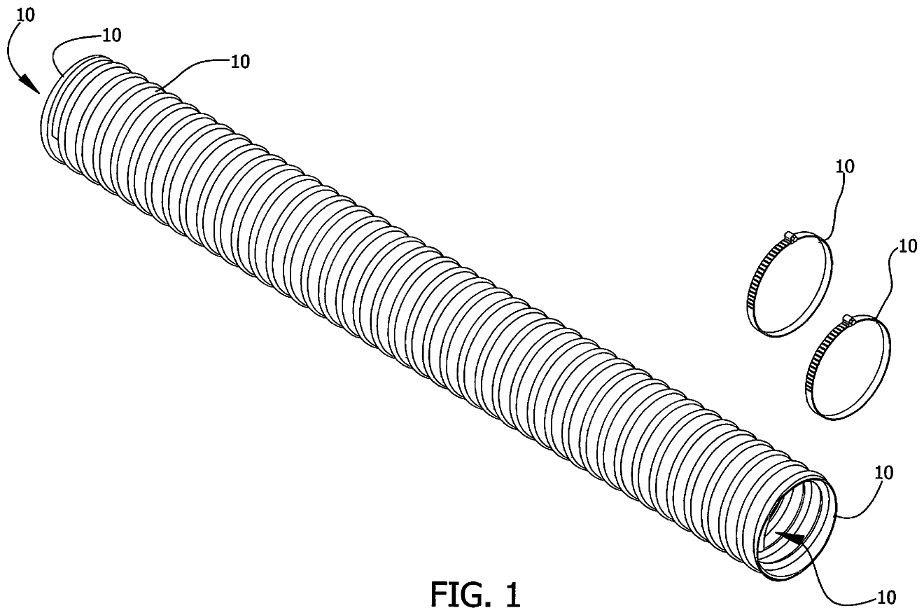

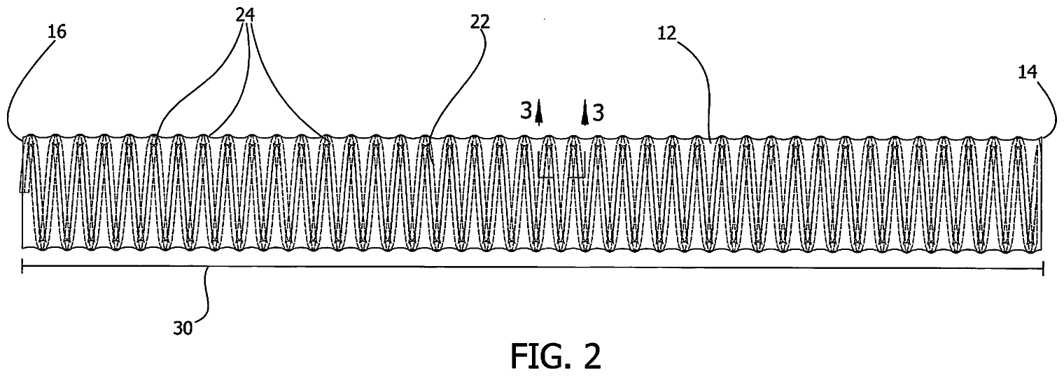

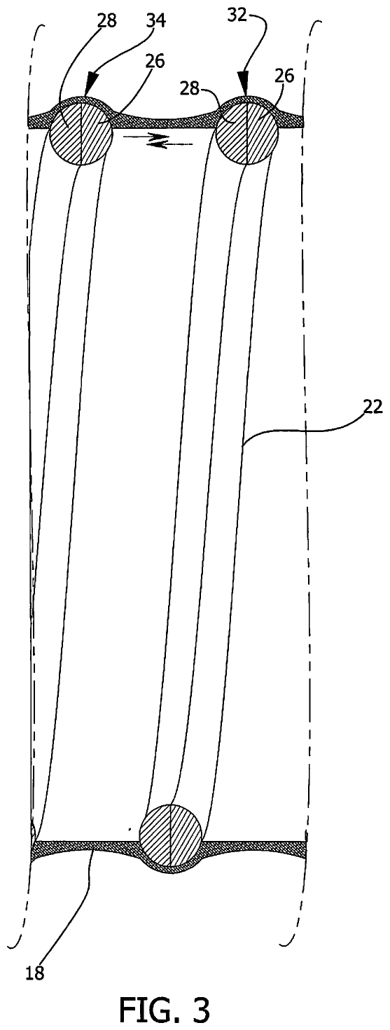

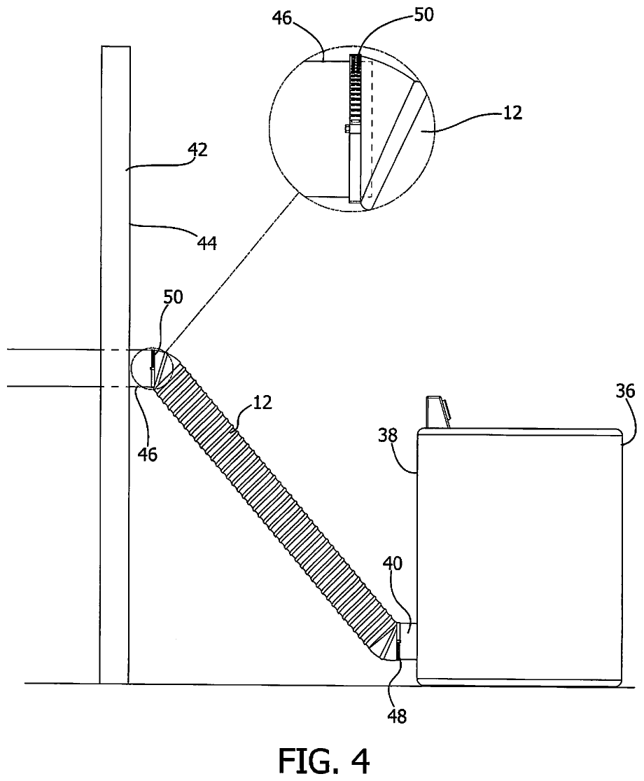

With reference now to the drawings, and in particular to FIGS. 1 through 4 thereof, a new vent hose embodying the principles and concepts of an embodiment of the disclosure and generally designated by the reference numeral 10 will be described.

As best illustrated in FIGS. 1 through 4, the dryer vent hose device 10 generally comprises a tube 12 having a first end 14, a second end 16, and a peripheral wall 18 that is attached to and extends between the first end 14 and the second end 16 to define an interior space 20. The peripheral wall 18 may comprise an aluminum material. For example, the peripheral wall 18 may comprise a heavy duty, fire resistant aluminum foil laminate. In some embodiments, the tube 12 may have an inner diameter between 3.0 inches and 5.0 inches.

A wire 22 is coupled to the peripheral wall 18. The wire 22 extends from the first end 14 to the second end 16. The wire 22 is generally positioned in the interior space 20, on an interior surface of the peripheral wall 18. The wire 22 generally comprises a helix shape forming a plurality of loops 24 along a length of the peripheral wall 18. The plurality of loops 24 are generally aligned with each other from the first end 14 to the second end 16 of the tube 12.

The wire 22 further comprises a first side 26 having a first polarity and a second side 28 having a second polarity. The first polarity and the second polarity are magnetically attracted to each other whereby the plurality of loops 24 are magnetically attracted to each other thereby retracting the plurality of loops 24 inwardly toward each other along the length of the peripheral wall.

The first side 26 of a first loop 32 of the plurality of loops 24 faces the second side 28 of a second loop 34 of the plurality of loops 24 whereby the first polarity pulls the first side 26 of the first loop 32 toward the second side 28 of the second loop 34 and draws the first loop 32 and the second loop 34 together thereby retracting the peripheral wall 18 such that the tube 12 remains taut between the first loop 32 and the second loop 34.

This pattern is repeated along a full length of the tube 30, so that the peripheral wall 18 of the tube 12 remains taught between the first end 14 and the second end 16. The first side 26 of each of the plurality of loops 24 faces the first end 14 of the tube 12 along the full length of the tube 30. The second side 28 of each of the plurality of loops 24 faces the second end 16 of the tube 12 along the full length of the tube 30. The full length of the tube 30 is from the first end 14 to the second end 16 of the tube 12. With this repeated pattern of opposing polarities along the full length of the tube 30, the tube 12 remains taut between the first end 14 and the second end 16.

In use, the dryer vent hose device 10 may be coupled between a dryer vent 40 and a wall vent 46 for an electric dryer 36, or another appliance. For example, the electric dryer 36, or other appliance, may include a back side 38 and a dryer vent 40 that is attached to and extends outwardly from the back side 38. The electric dryer 36 may be positioned proximate to a wall 42 having an exterior surface 44 and a wall vent 46 that is attached to and extends outwardly from the exterior surface 44.

The tube 12 may be coupled to and extend between the dryer vent 40 and the wall vent 46. A first worm clamp 48 may couple the first end 14 of the tube 12 to the dryer vent 40. A second worm clamp 50 may couple the second end 16 of the tube 12 to the wall vent 46. The first polarity and the second polarity of the wire 22 retains the tube 12 in a taut position between the dryer vent 40 and the wall vent 46.

The magnetic attraction between the first side 26 and the second side 28 of each of the plurality of loops 24 may compact the tube 12 when moving the electric dryer 36, or other appliance, closer to the wall 42. Thus, the wire 22 may inhibit kinking or unwanted constriction of the tube 12. The magnetic attraction between the first side 26 and the second side 28 of each of the plurality of loops 24 also facilitates the preservation of a straight-line conduit through the interior space 20 of the tube 12 to inhibit clogging.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vent hose assembly for an electric dryer, the vent hose assembly comprising:
a tube having a first end, a second end, and a peripheral wall being attached to and extending between the first end and the second end;
a wire being coupled to the peripheral wall, the wire extending from the first end to the second end, the wire comprising a helix shape forming a plurality of loops along a length of the peripheral wall, the wire further comprising:
a first side having a first polarity;
a second side having a second polarity; and
the first polarity and the second polarity being magnetically attracted to each other whereby the plurality of loops are magnetically attracted to each other thereby retracting the plurality of loops inwardly toward each other.

2. The vent hose assembly of claim 1, wherein the peripheral wall is an aluminum material.

3. The vent hose assembly of claim 1, wherein the wire is positioned on an interior surface of the peripheral wall.

4. The vent hose assembly of claim 1, wherein the first side of a first loop of the plurality of loops faces the second side of a second loop of the plurality of loops whereby the first polarity pulls the first side of the first loop toward the second side of the second loop and draws the first loop and the second loop together thereby retracting the peripheral wall such that the tube remains taut between the first loop and the second loop.

5. The vent hose assembly of claim 1, wherein the first side of each of the plurality of loops faces the first end of the tube along a full length of the tube, and wherein the second side of each of the plurality of loops faces the second end of the tube along the full length of the tube, the full length of the tube being from the first end to the second end of the tube.

6. A vent hose assembly for an electric dryer, the vent hose assembly comprising:
a tube having a first end, a second end, and a peripheral wall being attached to and extending between the first end and the second end, the peripheral wall comprising an aluminum material;
a wire being coupled to the peripheral wall, the wire extending from the first end to the second end, the wire being positioned on an interior surface of the peripheral wall, the wire comprising a helix shape forming a plurality of loops along a length of the peripheral wall, the wire further comprising:
a first side having a first polarity;
a second side having a second polarity;
the first polarity and the second polarity being magnetically attracted to each other whereby the plurality of loops are magnetically attracted to each other thereby retracting the plurality of loops inwardly toward each other;
the first side of a first loop of the plurality of loops facing the second side of a second loop of the plurality of loops whereby the first polarity pulls the first side of the first loop toward the second side of the second loop and draws the first loop and the second loop together thereby retracting the peripheral wall such that the tube remains taut between the first loop and the second loop;
the first side of each of the plurality of loops facing the first end of the tube along a full length of the tube and the second side of each of the plurality of loops facing the second end of the tube along the full length of the tube, the full length of the tube being from the first end to the second end of the tube whereby the tube remains taut between the first end and the second end.

7. A vent hose system comprising:
an electric dryer having a back side and a dryer vent being attached to and extending outwardly from the back side;
a wall having an exterior surface and a wall vent being attached to and extending outwardly from the exterior surface;
a tube being coupled to and extending between the dryer vent and the wall vent, the tube having a first end, a second end, and a peripheral wall being attached to and extending between the first end and the second end, the peripheral wall comprising an aluminum material;
a wire being coupled to the peripheral wall, the wire extending from the first end to the second end, the wire being positioned on an interior surface of the peripheral wall, the wire comprising a helix shape forming a plurality of loops along a length of the peripheral wall, the wire further comprising:
a first side having a first polarity;
a second side having a second polarity;
the first polarity and the second polarity being magnetically attracted to each other whereby the plurality of loops are magnetically attracted to each other thereby retracting the plurality of loops inwardly toward each other;
the first side of a first loop of the plurality of loops facing the second side of a second loop of the plurality of loops whereby the first polarity pulls the first side of the first loop toward the second side of the second loop and draws the first loop and the second loop together thereby retracting the peripheral wall such that the tube remains taut between the first end and the second end;
a first worm clamp coupling the first end of the tube to the dryer vent;
a second worm clamp coupling the second end of the tube to the wall vent; and
wherein the first polarity and the second polarity of the wire retains the tube in a taut position between the dryer vent and the wall vent.
